(19) United States
(12) Patent Application Publication
(10) Pub. No.: US 2026/0272771 A1
(43) Pub. Date: Sep. 17, 2026

(54) MASSAGE VIBRATION MECHANISM

(71) Applicant: Dongguan Yixu Technology Co., Ltd., Dongguan (CN)

(72) Inventor: Xudong LI, Dongguan (CN)

(73) Assignee: Dongguan Yixu Technology Co., Ltd., Dongguan (CN)

(21) Appl. No.: 19/304,366

(22) Filed: Aug. 19, 2025

(30) Foreign Application Priority Data
Mar. 14, 2025 (CN) 202520451438.5

(51) Int. Cl. A61H 23/02

(52) U.S. Cl. CPC A61H 23/0254; A61H 2201/0153; A61H 2201/123

(57) ABSTRACT

A massage vibration mechanism is provided, which relates to the field of massage devices. A battery and a drive mechanism are disposed inside a handle, a drive sleeve is connected to a drive end at a front part of the drive mechanism, a main housing is sleeved on an outer side of the drive sleeve, a swing assembly is disposed at the front of the drive sleeve, and a front-end assembly is disposed at the front of the drive sleeve; and an outer surface of the drive sleeve is provided with a helical sliding groove, and two sliding members pass through the main housing and are embedded in the helical sliding groove. The massage vibration mechanism can achieve functions of a transmission massage gun and a fascia gun and has stable massage effects without intense pain, which is more suitable for female users.

### CROSS-REFERENCE TO RELATED APPLICATIONS

The application claims priority to Chinese patent application No. 202520451438.5, filed on March 14, 2025, the entire contents of which are incorporated herein by reference.

### TECHNICAL FIELD

This application relates to the field of massage devices, and in particular to improvement of a high-efficiency vibrating massage mechanism.

### BACKGROUND

Existing massage vibrators on the market generally generate vibration by using DC motors to drive eccentric wheels or in a pressing vibration method, but there are significant problems with vibration efficiency and uniformity of vibration sensation. Due to the offset of the eccentric wheels during operation, this leads to a great current and greatly increased power consumption.

Most of current massage vibrators on the market use pressing massage vibrators, which can serve as fascia guns or massage vibration apparatuses for the backs and legs. Such apparatuses consume energy quickly, have uncontrollable vibration efficiency, and can easily cause a strong pain sensation for users. In addition, massage heads of these massage mechanisms are difficult to replace with a single vibration mode, making it hard to meet different user needs. For example, current massage guns and a fascia guns all relax human muscles through self-vibration, but cannot achieve percussive or rolling massage.

### SUMMARY

This application is intended to provide a massage vibration mechanism to address the defects and shortcomings of the prior art. The massage vibration mechanism can achieve functions of a transmission massage gun and a fascia gun, and can also perform percussive relaxation massage and rolling massage. In addition, the massage vibration mechanism also has stable massage effects without intense pain, which increases comfort and is more suitable for female users.

To achieve the above purpose, this application adopts the following technical solution: a handle 1, a battery 2, a drive mechanism 3, a drive sleeve 4, a main housing 5, a swing assembly 6, a front-end assembly 7, and a sliding member 8 are provided. The battery 2 and the drive mechanism 3 are disposed inside the handle 1, the drive sleeve 4 is connected to a drive end at a front part of the drive mechanism 3, the main housing 5 is sleeved on an outer side of the drive sleeve 4, the swing assembly 6 is disposed at the front of the drive sleeve 4, and the front-end assembly 7 is disposed at the front of the drive sleeve 4; and an outer surface of the drive sleeve 4 is provided with a helical sliding groove 41, and two sliding members 8 pass through the main housing 5 and are embedded in the helical sliding groove 41.

During use, the drive mechanism 3 drives the drive sleeve 4 to rotate, and rotation of the drive sleeve 4 drives the sliding member 8 to move linearly. In addition, the swing assembly 6 swings rotationally driven by the rotation of the drive sleeve 4.

The swing assembly 6 includes a first shaft sleeve 61, a second shaft sleeve 62, a first rotating shaft 63, a second rotating shaft 64, and a swing wave ball member 65. One end of the first rotating shaft 63 is connected to the drive sleeve 4 through the first shaft sleeve 61, and an oblique central shaft 631 is disposed on one side of the first rotating shaft 63. The swing wave ball member 65 is firmly attached to the oblique central shaft 631, the second rotating shaft 64 is sleeved at an end of the oblique central shaft 631, and the second shaft sleeve 62 is connected to the second rotating shaft 64. The swing assembly 6 achieves radial swinging of the swing wave ball member 65 through radial rotation of the oblique central shaft 631.

An outer surface of the main housing 5 is provided with a sliding member limiting groove 51 and a swing member limiting groove 52, and a swing ball 651 of the swing wave ball member 65 is disposed in the swing member limiting groove 52. The sliding member limiting groove 51 and the swing member limiting groove 52 can provide limiting for the sliding member 8 and the swing wave ball member 65.

An outer surface of the sliding member 8 is provided with a plurality of evenly distributed massage protruding beads 81. The massage protruding beads 81 are configured to enhance user experience during rolling massage on a human body, and different sliding members 8 with varying surfaces can be replaced according to user needs.

The front-end assembly 7 includes an outer housing 71, a motor housing 72, and a motor 73. The motor housing 72 is connected to a front end of the swing wave ball member 65, the motor 73 is disposed inside the motor housing 72, and an outer surface of the motor housing 72 is wrapped by the outer housing 71.

The motor housing 72 is connected to the swing wave ball member 65 through a housing connecting shaft 721, and the housing connecting shaft 72 is disposed obliquely. The housing connecting shaft 72 is disposed obliquely, so that the front-end assembly 7 can swing entirely.

The drive mechanism 3 includes a drive motor 31 and a speed reducing mechanism 32. A power end of the drive motor 31 is connected to a power end of the battery 2, a drive input end of the speed reducing mechanism 32 is connected to the drive motor 31, and an output end of the speed reducing mechanism 32 is connected to the drive sleeve 4.

The handle 1 and the main housing 5 are both formed by assembling upper and lower housings.

A connecting block 82 is provided on a back surface of the sliding member 8, and the connecting block 82 is embedded in the helical sliding groove 41.

The working principle of this application: In this case, the sliding member 8 can achieve radial sliding to implement rolling massage on a human body, and the massage mimics finger movements of a human hand to provide better user experience. The swing assembly 6 can achieve better swinging and vibration effects, and the front-end assembly 7 can implement rotation or vibration by the internal motor, thereby achieving an overall multi-mode massage effect.

After the above technical solution is used, beneficial effects of this application are as follows: an eccentric wheel and an elastic support structure are provided, to provide more uniform vibration sensation and improve the massage effect; and the use of the low-power motor and speed reducing mechanism increases battery life and reduces energy consumption. A silicone buffer layer can be added to the massage head to reduce vibration rigidity and improve user experience. The protective housing is made of ABS plastic or silicone material, which is wear-resistant, waterproof, and easy to clean. The overall design is ergonomic, with a shape that fits a hand grip habit, which is easily operated, improving user experience.

### BRIEF DESCRIPTION OF DRAWINGS

To describe the solutions in embodiments of this application or in the conventional technology more clearly, the following briefly describes the accompanying drawings for describing embodiments or the conventional technology. It is clear that the accompanying drawings in the following descriptions show merely some embodiments of this application, and a person of ordinary skill in the art may still derive other drawings from these accompanying drawings without creative efforts.

FIG. 1 is a structural schematic diagram of this application;

FIG. 2 is a full sectional view of FIG. 1;

FIG. 3 is a schematic diagram of a connection structure of a drive mechanism 3 and a swing assembly 6 in this application;

FIG. 4 is an exploded view of FIG. 3;

FIG. 5 is a schematic diagram of an internal structure of this application; and

FIG. 6 is a schematic diagram of an installation structure of a swing wave ball member 65 in this application.

Reference numeral description: handle 1, battery 2, drive mechanism 3, drive sleeve 4, main housing 5, swing assembly 6, front-end assembly 7, sliding member 8, helical sliding groove 41, first shaft sleeve 61, second shaft sleeve 62, first rotating shaft 63, second rotating shaft 64, swing wave ball member 65, oblique central shaft 631, sliding member limiting groove 51, swing member limiting groove 52, swing ball 651, massage protruding bead 81, outer housing 71, motor housing 72, motor 73, housing connecting shaft 721, drive motor 31, and speed reducing mechanism 32.

### DETAILED DESCRIPTION OF THE EMBODIMENTS

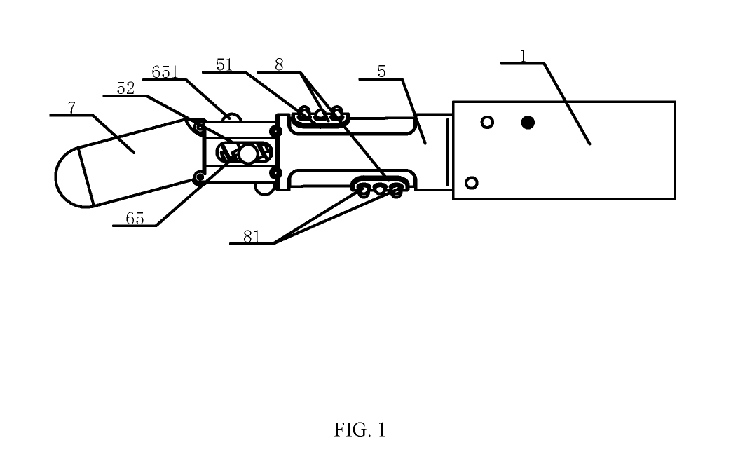

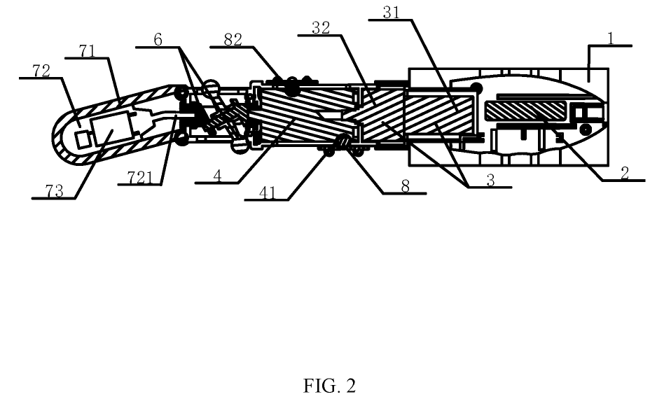

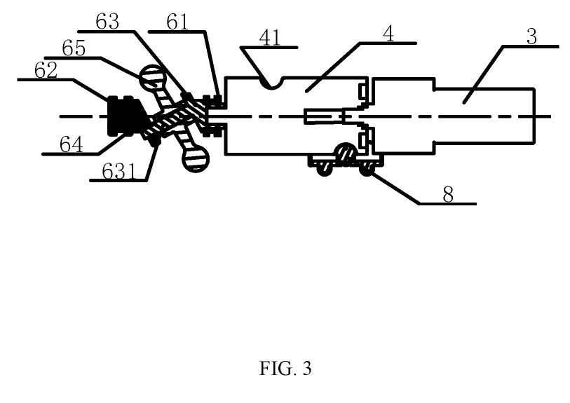

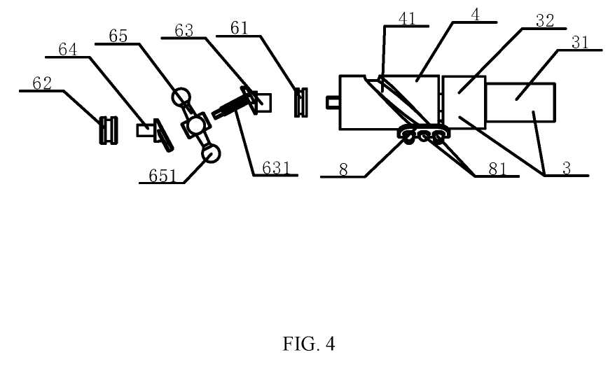

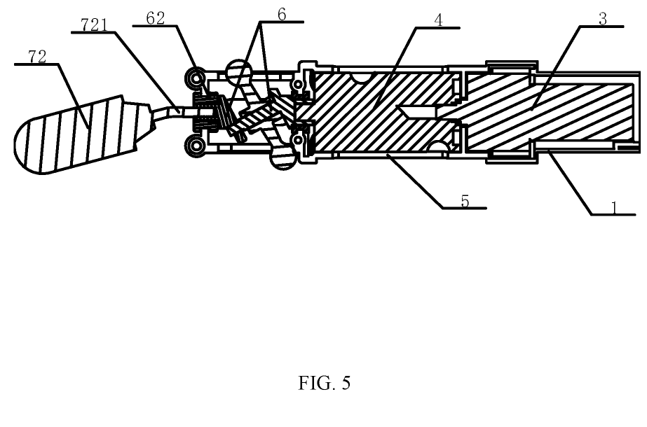

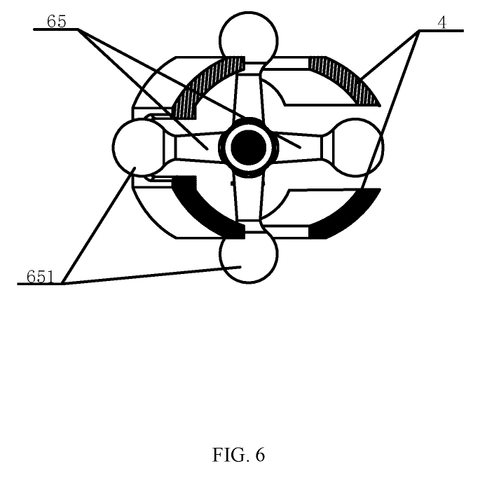

Refer to FIG. 1 to FIG. 6. The technical solution used in this specific implementation is as follows: a handle 1, a battery 2, a drive mechanism 3, a drive sleeve 4, a main housing 5, a swing assembly 6, a front-end assembly 7, and a sliding member 8 are included. The battery 2 and the drive mechanism 3 are disposed inside the handle 1, the drive sleeve 4 is connected to a drive end at a front part of the drive mechanism 3, the main housing 5 is sleeved on an outer side of the drive sleeve 4, the swing assembly 6 is disposed at the front of the drive sleeve 4, and the front-end assembly 7 is disposed at the front of the drive sleeve 4; and an outer surface of the drive sleeve 4 is provided with a helical sliding groove 41, and two sliding members 8 pass through the main housing 5 and are embedded in the helical sliding groove 41. The swing assembly 6 includes a first shaft sleeve 61, a second shaft sleeve 62, a first rotating shaft 63, a second rotating shaft 64, and a swing wave ball member 65. One end of the first rotating shaft 63 is connected to the drive sleeve 4 through the first shaft sleeve 61, and an oblique central shaft 631 is disposed on one side of the first rotating shaft 63. The swing wave ball member 65 is firmly attached to the oblique central shaft 631, the second rotating shaft 64 is sleeved at an end of the oblique central shaft 631, and the second shaft sleeve 62 is connected to the second rotating shaft 64. An outer surface of the main housing 5 is provided with a sliding member limiting groove 51 and a swing member limiting groove 52, and a swing ball 651 of the swing wave ball member 65 is disposed in the swing member limiting groove 52. An outer surface of the sliding member 8 is provided with a plurality of evenly distributed massage protruding beads 81. The front-end assembly 7 includes an outer housing 71, a motor housing 72, and a motor 73. The motor housing 72 is connected to a front end of the swing wave ball member 65, the motor 73 is disposed inside the motor housing 72, and an outer surface of the motor housing 72 is wrapped by the outer housing 71. The motor housing 72 is connected to the swing wave ball member 65 through a housing connecting shaft 721, and the housing connecting shaft 72 is disposed obliquely. The housing connecting shaft 72 is disposed obliquely, so that the front-end assembly 7 can swing entirely. The drive mechanism 3 includes a drive motor 31 and a speed reducing mechanism 32. A power end of the drive motor 31 is connected to a power end of the battery 2, a drive input end of the speed reducing mechanism 32 is connected to the drive motor 31, and an output end of the speed reducing mechanism 32 is connected to the drive sleeve 4. The handle 1 and the main housing 5 are both formed by assembling upper and lower housings.

In this case, the sliding member 8 can achieve radial sliding to implement rolling massage on a human body, and the massage mimics finger movements of a human hand to provide better user experience. The swing assembly 6 can achieve better swinging and vibration effects, and the front-end assembly 7 can implement rotation or vibration by the internal motor, thereby achieving an overall multi-mode massage effect.

After the above technical solution is used, beneficial effects of this application are as follows: an eccentric wheel and an elastic support structure are provided, to provide more uniform vibration sensation and improve the massage effect; and overall integration of the product simplifies an assembly difficulty. The use of the low-power motor and speed reducing mechanism increases battery life and reduces energy consumption. A silicone buffer layer can be added to the massage head to reduce vibration rigidity and improve user experience. The protective housing is made of ABS plastic or silicone material, which is wear-resistant, waterproof, and easy to clean. The overall design is ergonomic, with a shape that fits a hand grip habit, which is easily operated, improving user experience.

The above description is only used to illustrate but not limit the technical solutions of this application, and other modifications or equivalent substitutions made by a person skilled in the art to the technical solutions of the present invention shall fall within the scope of the claims of this application as long as the modifications or equivalent substitutions do not deviate from the spirit and scope of the technical solutions of this application.

What is claimed is:

1. A massage vibration mechanism, comprising a handle, a battery, a drive mechanism, a drive sleeve, a main housing, a swing assembly, a front-end assembly, and a sliding member, wherein the battery and the drive mechanism are disposed inside the handle, the drive sleeve is connected to a drive end at a front part of the drive mechanism, the main housing is sleeved on an outer side of the drive sleeve, the swing assembly is disposed at the front of the drive sleeve, and the front-end assembly is disposed at the front of the drive sleeve; and an outer surface of the drive sleeve is provided with a helical sliding groove, and two sliding members pass through the main housing and are embedded in the helical sliding groove.

2. The massage vibration mechanism according to claim 1, wherein the swing assembly comprises a first shaft sleeve, a second shaft sleeve, a first rotating shaft, a second rotating shaft, and a swing wave ball member, one end of the first rotating shaft is connected to the drive sleeve through the first shaft sleeve, and an oblique central shaft is disposed on one side of the first rotating shaft, the swing wave ball member is firmly attached to the oblique central shaft, the second rotating shaft is sleeved at an end of the oblique central shaft, and the second shaft sleeve is connected to the second rotating shaft.

3. The massage vibration mechanism according to claim 1, wherein an outer surface of the main housing is provided with a sliding member limiting groove and a swing member limiting groove, and a swing ball of the swing wave ball member is disposed in the swing member limiting groove.

4. The massage vibration mechanism according to claim 1, wherein an outer surface of the sliding member is provided with a plurality of evenly distributed massage protruding beads.

5. The massage vibration mechanism according to claim 1, wherein the front-end assembly comprises an outer housing, a motor housing, and a motor, the motor housing is connected to a front end of the swing wave ball member, the motor is disposed inside the motor housing, and an outer surface of the motor housing is wrapped by the outer housing.

6. The massage vibration mechanism according to claim 5, wherein the motor housing is connected to the swing wave ball member through a housing connecting shaft, and the housing connecting shaft is disposed obliquely.

7. The massage vibration mechanism according to claim 1, wherein the drive mechanism comprises a drive motor and a speed reducing mechanism, a power end of the drive motor is connected to a power end of the battery, a drive input end of the speed reducing mechanism is connected to the drive motor, and an output end of the speed reducing mechanism is connected to the drive sleeve.

8. The massage vibration mechanism according to claim 1, wherein the handle and the main housing are both formed by assembling upper and lower housings.

9. The massage vibration mechanism according to claim 1, wherein a connecting block is provided on a back surface of the sliding member, and the connecting block is embedded in the helical sliding groove.
